(19) United States
(12) Patent Application Publication
(10) Pub. No.: US 2006/0232398 A1
(43) Pub. Date: Oct. 19, 2006

(54) System for personal possessions security

(76) Inventors: Greydon W. Nedblake, Kansas City, MO (US); Larry Johnson, Gladstone, MO (US)

Correspondence Address: HOVEY WILLIAMS LLP, 2405 GRAND BLVD., SUITE 400, KANSAS CITY, MO, 64108, US

(21) Appl. No.: 11/105,863

(22) Filed: Apr. 14, 2005

(51) Int. Cl. G08B 1/08

(52) U.S. Cl. 340/539.13; 340/10.51

(57) ABSTRACT

Systems and methods of using those systems to secure and track personal possessions are disclosed. Generally, such systems comprise a portable communication device having incorporated therein security device detection circuitry, location identification circuitry, and wireless communication circuitry, and a security device attached to the object to be secured and capable of being detected by the security device detection circuitry. Also, methods of retrofitting existing electronic devices to function in accordance with the present invention by providing a replacement battery are also described.

### BACKGROUND OF THE INVENTION

1. Field of the Invention

The present invention is generally directed toward systems for securing and keeping track of personal possessions employing a security device attached to the object to be secured or tracked, a portable communication device including security device detection circuitry, location identification circuitry, and wireless communication circuitry.

2. Description of the Prior Art

The inadvertent loss or theft of valuable objects presents many problems not only for the owners of the objects, but also companies responsible for their loss and replacement. For example, the loss or theft and subsequent misuse of credit cards represents a significant problem for card issuers especially because of consumer protection laws limiting the liability of the card holder for improper charges. The credit card issuer becomes responsible for these unauthorized charges or must seek to recoup the loss from the retailer who inappropriately accepted payment. In short, such credit card misuses cost the industry millions, if not billions, of dollars annually.

Also, if owners of valuable property such as watches, jewelry, etc. could be assisted in locating items inadvertently lost, insurance companies could potentially avoid having to pay claims for these losses. Such a reduction in loss has the potential to save the industry millions of which at least a portion could be passed along to consumers.

Presently, there does not exist a simple or effective system for securing these every day objects. Therefore, there is a need for a security system for personal possessions that not only notifies the user of a loss, but also assists in locating or tracking down the item's whereabouts.

### SUMMARY OF THE INVENTION

The present invention overcomes the above problems by providing a systems and methods for protecting personal possessions. In one embodiment, a system for protecting personal possessions is provided comprising a portable communication device having incorporated therein security device detection circuitry, location identification circuitry, and wireless communication circuitry; and a security device attached to an object and capable of being detected by the security device detection circuitry.

In another embodiment, a system for tracking personal possessions is provided comprising an RFID device attached to an object to be tracked; and a portable communication device including—an RFID reader, circuitry capable of determining the location of the communication device using either terrestrial or non-terrestrial signals, apparatus for wirelessly transmitting information about the object and the location of the communication device.

In yet another embodiment, a system for protecting personal possessions is provided comprising a credit card including an RFID device; and a portable communication device having incorporated therein an RFID reader capable of detecting the RFID device, location identification circuitry for determining the position of the portable communication device, and wireless communication circuitry for transmitting information about the credit card and the location of the communication device.

In a further embodiment, a method for protecting personal possessions is provided comprising providing an object including a security device; activating security device detection circuitry contained within a portable communication device for detecting the presence of the security device; and if the security device detection circuitry detects the security device, the portable communication device waits a predetermined length of time and attempts to detect the security device again, or, if said security device detection circuitry fails to detect the security device, location identification circuitry contained within the portable communication device determines the location of the communication device using either terrestrial or non-terrestrial signals.

In still another embodiment, a method for tracking personal possessions of a user is provided comprising: associating an object with an RFID device that is attached thereto; attempting to detect the RFID device using a portable communication device including an RFID interrogator; and if the RFID reader detects the RFID device, the portable communication device pauses for a predetermined time period and attempts to detect the RFID device again, or if the RFID reader does not detect the RFID device, the portable communication device determines its location using location identification circuitry contained within the portable communication device, and alerts the user of the detection failure and prompts the user to either confirm the detection failure or instruction the communication device to ignore said detection failure, if the user confirms the detection failure or fails to confirm or fails to instruct the communication device to ignore the detection failure, wireless communication circuitry contained within the portable communication device transmits data regarding the object and the location of the portable communication device at the time of detection failure to a central computer system.

In yet another embodiment, a method for protecting personal possessions is provided comprising providing a credit card including an RFID device; attempting to detect the RFID device using an RFID reader built in to a portable communication device; and if the RFID reader fails to detect the RFID device, location identification circuitry built in to the portable communication device determines the location of the portable communication device at the time of detection failure.

### BRIEF DESCRIPTION OF THE DRAWINGS

FIG. 1 is a depiction of a credit card comprising an RFID device in communication with an RFID interrogating device housed within a cellular phone.

FIG. 2 shows a credit card that is out of communication with the RFID reader housed in the cellular phone, and the cellular phone determining its location using GPS technology and relaying information via a cellular communication network.

FIG. 3 is a flow diagram of one embodiment of a method according to the present invention.

FIG. 4 is a flow diagram of another embodiment of a method according to the present invention whereby a user is prompted to give an instruction to the communication device.

FIG. 5 is a flow diagram of yet another embodiment of a method according to the present invention whereby an internal counter is employed to avoid the transmission of inadvertent “device unresponsive” messages to the user and central computer system.

### DETAILED DESCRIPTION OF THE PREFERRED EMBODIMENT

The following description sets forth exemplary and preferred embodiments according to the present invention. It is to be understood, however, that these examples are provided by way of illustration and nothing therein should be taken as a limitation upon the overall scope of the invention.

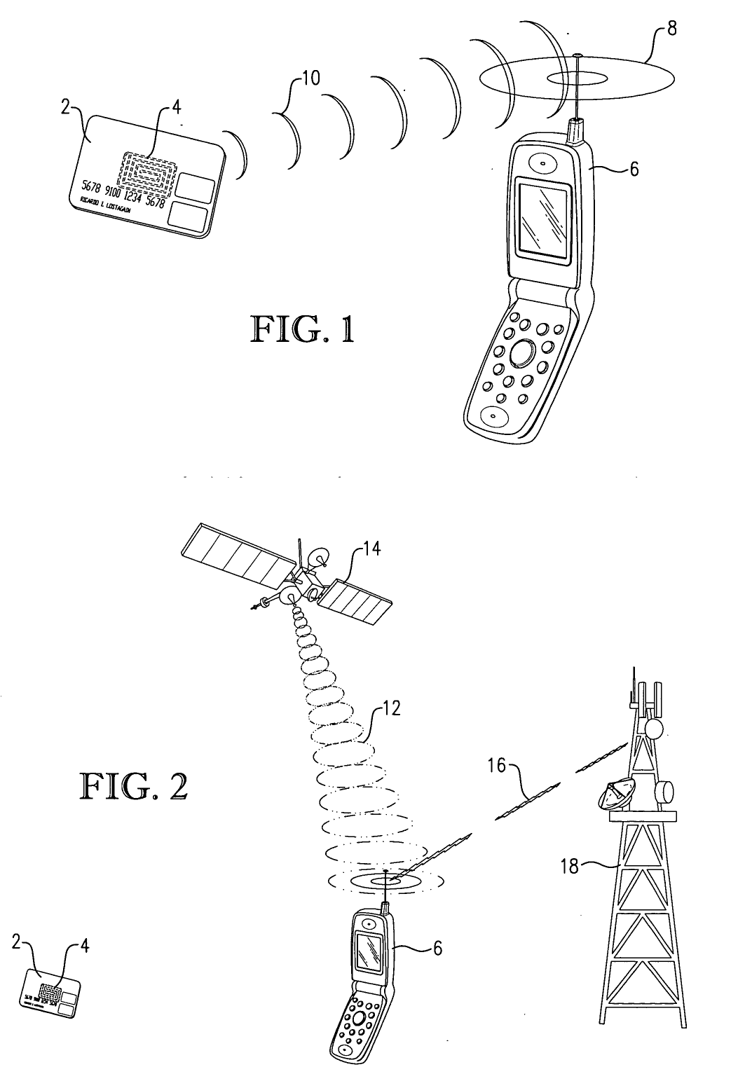

The present invention is directed toward a system for protecting personal possessions, particularly those that are readily susceptible to loss or theft. The object to be protected comprises a security device attached thereto. In FIG. 1, the particular object to be protected is a credit card 2, however, it is understood that this depiction is only exemplary as the object to be protected could be any personal possession including but not limited to watches, pens, jewelry, keys, wallets, purses, and any other such valuable possession. As used herein, the term “credit card” means credit, debit, ATM or other such cards issued by financial institutions.

Credit card 2 includes an RFID device 4 therein. Credit card 2 is preferably formed by laminating RFID device 4 between two plastic sheets, however, it is not necessary for the device sought to be protected by the present invention to be formed with the security device therein. Any security device, such as an RFID tag, may be placed upon a pre-fabricated object at the owner's discretion. In such an embodiment, a user could purchase individual pressure sensitive RFID tags and apply them to objects that he or she would like to protect. The illustration of an RFID tag in FIG. 1 is exemplary and not intended to be a limitation on the scope of the invention. Other security devices such as Electronic Article Surveillance (EAS) devices may also be employed.

A communication device 6 is provided that includes security device detection circuitry for detecting the presence of the security device, namely, RFID device 4. As illustrated in FIG. 1, communication device 6 comprises a cellular phone. However, it is understood that any communication device having wireless communication capability may be used (i.e., PDAs, pagers, Blackberries, portable computers, satellite phones, headphones, etc.). In the embodiment illustrated, the security device detection circuitry comprises an RFID reader. The RFID reader is built into communication device 6 and emits radio waves 8 over a relatively short distance (preferably a maximum range of between 1-30 feet), but sufficient for establishing contact with RFID device 4 as it is being carried on the person of the user.

Radio waves 8 from the RFID reader contact RFID device 4 thereby causing RFID device 4 to transmit a responsive signal 10 back to the RFID reader. The RFID reader is preferably an RFID reader/writer presenting “writing” capabilities for uploading data to RFID device 4 input by the user. Such data input can include object identification information. For example, if the object to be protected was not initially fabricated with an RFID tag, but rather the RFID tag was placed on the deice by the user, the user could program the RFID tag with the name of the good on which it was placed (such as “watch” or “jewelry”). As explained below, associating particular RFID tags with the name of the object on which it is placed facilitates easy identification of the object by the user.

Conversely, the unique, pre-programmed identifier (generally an alpha-numeric code) may be associated with a particular good and stored in the memory of the communication device instead of uploading the object named to the RFID tag. In this particular embodiment, the RFID interrogator would initially obtain the unique identifier from the RFID tag and prompt the user to associate a brief description of the good with this identifier.

The system protects credit card 2 by maintaining periodic contact with RFID device 4 using the RFID reader housed in communication device 6. At preset intervals, the RFID reader broadcasts a signal 8 and, if credit card 2 is within the operational range of the interrogator, RFID device 4 picks up signal 8 and transmits a reply signal 10. Upon detecting reply signal 10, the RFID reader waits a predetermined period of time and broadcasts signal 8 again to determine whether card 2 is still within range. This cycle continues indefinitely or until the RFID reader does not receive a reply signal from RFID device 4.

RFID device 4 may also be connected with its own power source such as a “watch battery” or other small, light weight battery (not shown). This enables the RFID device to transmit signals under its own power rather than relying upon the power generated by the signals from the RFID reader. This also allows the RFID device to continuously “squawk” its unique identifier which can be picked up by the RFID reader. This enables the RFID reader to avoid having to periodically broadcast its own radio waves thereby conserving power of communication device 6.

As shown in FIG. 2, if the RFID reader does not receive a reply signal from RFID device 4, location identification circuitry also housed within communication device 6 is activated and records the geographical position of communication device 6 at the time of the detection failure. There are a number of technologies that are available and that can be utilized to fill the role of the location identification circuitry. In one embodiment, the location identification circuitry comprises a GPS (Global Positioning System) transponder that determines the position of communication device 6 using signals 12 originating from at least three different satellites 14, and preferably at least four different satellites. GPS technology generally operates by “trilateration” (also commonly referred to as “triangulation”), that is, determining the relative positions of three or more points by treating these points as vertices of a triangle of which the angles and sides can be measured. Alternatively, the location identification circuitry comprises circuitry for determining the location of the communication device by triangulation of at least two (and preferably at least three) different terrestrial, or land-based, signals 16. For example, signals broadcast by cellular phone towers 18 may be used for this purpose. The FCC as a part of the Enhanced 911 Mandate, is requiring that wireless communication carriers incorporate location determination capabilities into their networks. Further, such location determination capabilities are also being incorporated into various heterogeneous location-based services providers.

As explained further below, at some point following failure to detect RFID device 4, wireless communication circuitry housed within communication device 6 can be activated to transmit information about credit card 2 and the location determined by the location identification circuitry to a central computer or data gathering system via existing cellular communication networks or satellite. From this point on, actions may be taken such as automatically notifying the credit card issuer of the card's loss so that account activity may be temporarily frozen. Also, an email or other form of electronic communication may be sent to the user's email account notifying the user of the loss and location where the communication device failed to detect the card.

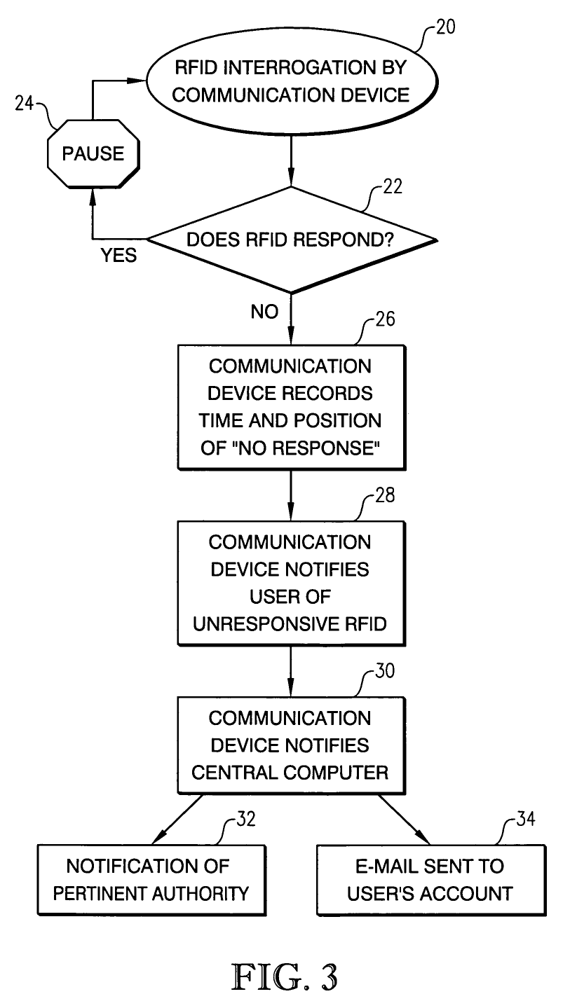

FIGS. 3-5 depict various methods of operation using the system described above. Turning now to FIG. 3, a simplified process flow diagram is provided showing an exemplary process according to the invention. Initially, represented by step 20, the RFID reader device housed within the communication device interrogates the RFID device located on the object to be protected. The RFID reader “listens” for a response from the RFID device 22. If the device responds, indicating that it is still within proximity of the reader, the reader pauses 24 for a length of time (set by the user or device manufacturer) and repeats step 20. The length of pause 24 is dependent in large part by the capabilities of the battery powering the communication device. In certain circumstances, it may be desirable for the communication device to go into a “power saving” mode during which time interrogations occur less frequently in order to conserve power.

If the RFID device does not respond, the communication device records the time and location of the response failure 26. As noted above, location identification circuitry determines the position of the communication device by triangulation of terrestrial or non-terrestrial signals

Next, the communication device sends an audio and/or visual notification of the unresponsive RFID device to the user 28. This notification may comprise a “tone” or “beep” alerting the user that the object being protected is no longer within range of the communication device. Different sounds could be programmed by the user corresponding to different objects. Alternatively, or conjunctively, the screen of the communication device can display a message indicating which particular object is no longer in contact. In order to correctly identify the object for which contact has been lost, the communication device associates the unique RFID identifier with the corresponding label input by the user. For example, the user had previously programed the communication device that the object onto which RFID tag containing the identifier “11111111” is a watch. Upon failure to detect this particular RFID tag, the communication device may display a message such as “your watch is lost.”

The communication device then wirelessly transmits a notification to a central computer or data gathering system 30 that the object has been lost. Also contained within this communication may be information such as the user's identity, the location of the detection failure, and other information pertinent to the object. The central computer system can then notify the pertinent authority of the object's loss 32. The pertinent authority to be notified can vary depending upon the particular object. For example, if the object is a credit card, the pertinent authority would be the card's issuer, or if the object is a valuable jewelry item, law enforcement authorities or a private security company retained by the owner can be notified. Also, the central computer system can send an email 34 or other notification to the user alerting him or her of the loss in case he or she did not receive the alert from the communication device itself in step 28. Other operations are also possible at this point including notification of other responsible parties previously supplied by the user.

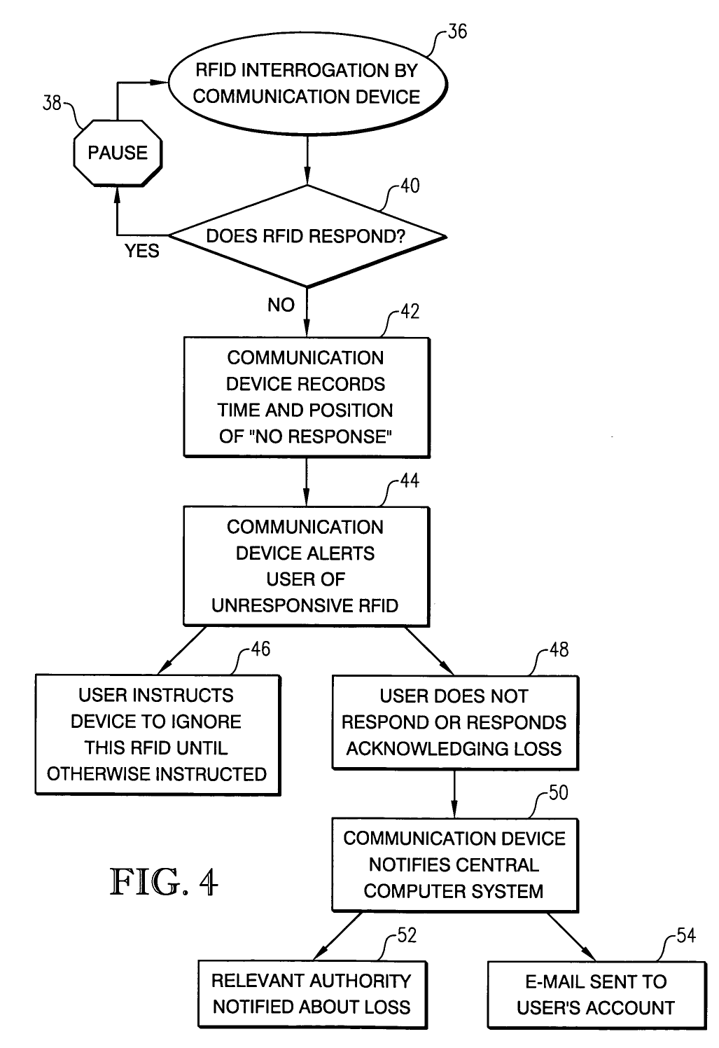

FIG. 4 depicts an alternate embodiment of the present invention whereby “false” unresponsive RFID alerts can be disposed of by the user prior to automatic notification of the central computer system. Steps 36-44 are substantially identical to step 20-28 of FIG. 3. In the process shown in FIG. 4, following notification of the user of the unresponsive RFID 44 by the communication device, the user has the ability to instruct the communication device to ignore the failure to detect this RFID tag until otherwise instructed 46. This may be accomplished by depressing a button on the communication device either turning the device off or commanding the device to attempt no further interrogations of a particular RFID tag until the user instructs the device to resume operation. This particular feature is useful when the RFID tag does not respond to interrogation, however, the user is fully aware of the location of the object bearing the tag.

For example, the user may have set his wallet containing credit card 2 on top of a dresser in the bedroom of his house and then left the room to go to the kitchen. The card would no longer be in range of the RFID reader thereby prompting the communication device to issue a “non-responsive RFID” alert. The user, knowing that his credit card is secure, instructs the communication device to ignore the unresponsive RFID device. By allowing the user to override the automatic notification of the central computer system, wasteful “false alarms” are avoided. By the same token, the user also has the option of acknowledging the loss of the object bearing the RFID tag thereby initiating immediate notification of the central computer system of the loss 48. However, if the user does not input a response within a predetermined time period, the communication device proceeds with notification of the central computer system 50 which then notifies the relevant authority of the loss 52 and sends an email or other notification to the user's account 54.

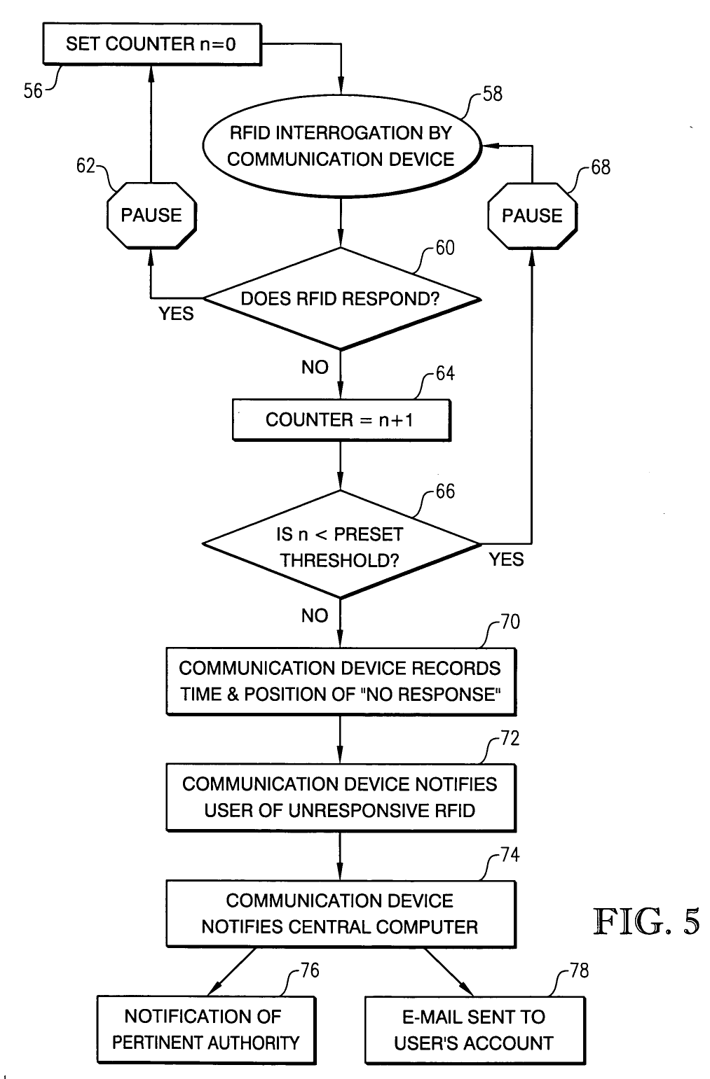

FIG. 5 depicts yet another process that may avoid generation of “false alarms” because of temporary interruptions between the RFID device and RFID reader. In this embodiment, a counter is used in order to allow for multiple detection failures prior to initiating time and location recordation and notification of non-responsiveness. Initially, the counter (represented as “n”) is set to zero 56. Next, the RFID reader contained within the communication device attempts to interrogate the RFID tag on the object being protected 58. The communication device then awaits a response from the RFID tag 60. If the RFID tag responds, the system pauses 62 for a preset time period before resetting the counter to zero and beginning the interrogation process again.

If the RFID tag does not respond one is added to the counter thereby increasing the value of “n” 64. Next, the communication device analyzes whether “n” has exceeded a predetermined threshold that is either input by the user or programmed by the manufacturer of the communication device 66. If “n” is less than the threshold level, the system pauses 68 and begins the interrogation process again without resetting the counter to zero. The cycle of interrogating and comparing the value of “n” to the preset threshold continues until the value of “n” has exceeded the threshold. Once “n” is no longer less than the threshold, the communication device records the time and position at which the threshold was exceeded 70. The rest of the process (steps 72-78) proceeds in substantially similar manner to steps 28-34 of FIG. 3.

The system illustrated in FIG. 5 effectively creates a delay between the first detection failure and notification of the central computer system of the loss. This is particularly useful in the instance where the object is briefly out of the owner's possession on occasion. Certain items, like credit cards, are handled by persons other than their owner during their normal course of operation. This time delay feature prevents such a normal event from being interpreted as a loss of the item. This delay can be set by the user to be whatever period with which he or she is comfortable.

Another advantage of this system is that it also acts to protect the communication device from loss. The audible warning generated once contact is lost between the communication device and RFID device may alert a user that he or she has just walked away from their communication device (PDA, cellular phone) or that it has been removed from her or her person. Thus, the present system also assists in loss prevention of the communication device.

Of course, it is certainly within the scope of the present invention to combine various features of FIGS. 3-5 in ways not presently illustrated. Also, additional features can be added to any of the processes without departing from the overall spirit of the invention.

Also contemplated within the scope of the present invention is the retrofitting of existing battery-powered (i.e., portable electronic) devices with circuitry for carrying out the aforementioned functions. For example, the battery pack of the device could be configured to contain at least one of the security device detection circuitry, location identification circuitry, wireless communication circuitry, or any combination thereof. The battery also contains an interface to the battery-powered device thereby enabling the battery-powered device controls to operate the circuitry contained within the battery. The only action required by the user to retrofit the battery-powered device to operate according to the present invention would be to purchase a replacement battery containing the necessary add-on circuitry which would be pre-programmed with the requisite software to enable operation with the battery-powered device.

In the context of a cellular phone, the replacement battery would contain security device detection circuitry and location identification circuitry (if not all ready enabled by the particular cellular phone). If the battery-powered device were an MP3 player, the replacement battery would contain security device detection circuitry, location identification circuitry, and wireless communication circuitry. Once the battery is installed, the user can easily activate the wireless communication circuitry with an wireless communications provider.

The replacement battery may also be supplied with software for upgrading the battery-powered device so as to allow the device to function as a part of a personal possessions security system as described herein. Such software would be uploaded to the battery-powered device upon installation of the replacement battery. Also, such software may be downloaded by the wireless communication circuitry and installed on the battery-powered device. In one such embodiment, the replacement battery contains basic software for initiating a remote download of the full software update that allows the electronic device to function in accordance with the present invention. For example, a cellular phone replacement battery may contain software instructing the cellular phone to wirelessly access, download, and install software upgrading or replacing the cellular phone's factory programmed software. Once installed, the new software enables the cellular phone to function as an integral part of the personal possessions security system.

We claim:

1. A system for protecting personal possessions comprising:
a portable communication device having incorporated therein security device detection circuitry, location identification circuitry, and wireless communication circuitry; and
a security device attached to an object and capable of being detected by said security device detection circuitry.

2. The system according to claim 1, said portable communication device comprising a cellular phone having incorporated therein security device detection circuitry and location identification circuitry.

3. The system according to claim 1, said location identification circuitry comprising a GPS transponder.

4. The system according to claim 1, said location identification circuitry comprising circuitry for determining the location of said portable communication device by triangulation of at least two different terrestrial signals.

5. The system according to claim 1, said security device comprising an RFID tag.

6. The system according to claim 5, said RFID tag including a battery thereby enabling said RFID tag to independently transmit a signal that is capable of being detected by said security device detection circuitry.

7. The system according to claim 5, said security device detection circuitry comprising an RFID reader.

8. The system according to claim 7, said RFID reader capable of programing said RFID tag attached to said object.

9. The system according to claim 5, said RFID tag being preprogrammed with a unique identifier.

10. The system according to claim 1, said portable communication device capable of communicating with existing cellular communication networks.

11. A system for tracking personal possessions comprising:
an RFID device attached to an object to be tracked; and
a portable communication device including—
an RFID reader,
circuitry capable of determining the location of said communication device using either terrestrial or non-terrestrial signals,
apparatus for wirelessly transmitting information about said object and the location of said communication device.

12. The system according to claim 11, said portable communication device comprising a cellular phone.

13. The system according to claim 11, said location determination circuitry comprising a GPS transponder.

14. The system according to claim 11, said location determination circuitry comprising circuitry for determining the location of said portable communication device by triangulation of at least two different terrestrial signals.

15. The system according to claim 11, said object comprising a credit card.

16. The system according to claim 11, said non-terrestrial signals comprising signals from at least three different global positioning satellites.

17. The system according to claim 11 said RFID tag including a battery thereby enabling said RFID tag to independently transmit a signal that is capable of being detected by said RFID reader.

18. A system for protecting personal possessions comprising:
a credit card including an RFID device; and
a portable communication device having incorporated therein an RFID reader capable of detecting said RFID device, location identification circuitry for determining the position of said portable communication device, and wireless communication circuitry for transmitting information about said credit card and the location of said communication device.

19. The system according to claim 18, said portable communication device comprising a cellular phone.

20. The system according to claim 18, said location identification circuitry comprising a GPS transponder.

21. The system according to claim 18, said location identification circuitry comprising circuitry for determining the location of said portable communication device by triangulation of at least two different terrestrial signals.

22. The system according to claim 18, said wireless communication circuitry capable of communicating with existing cellular communication networks.

23. A method for protecting personal possessions comprising:
providing an object including a security device;
activating security device detection circuitry contained within a portable communication device for detecting the presence of said security device; and
if said security device detection circuitry detects said security device, said portable communication device waits a predetermined length of time and attempts to detect said security device again, or
if said security device detection circuitry fails to detect said security device, location identification circuitry contained within said portable communication device determines the location of said communication device using either terrestrial or non-terrestrial signals.

24. The method according to claim 23, said security device being an RFID device.

25. The method according to claim 24, said RFID device including a battery thereby enabling said RFID device to independently transmit a signal to be detected by said security device detection circuitry.

26. The method according to claim 24, said security device detection circuitry comprising an RFID reader.

27. The method according to claim 23, said location identification circuitry comprising a GPS transponder and said non-terrestrial signals comprising signals from at least three global positioning satellites.

28. The method according to claim 23, said location identification circuitry comprising circuitry for determining the location of said portable communication device by triangulation of at least two different terrestrial signals.

29. The method according to claim 23, if said security detection circuitry fails to detect said security device, wireless communication circuitry transmits information about said object and the location of said communication device to a central computer system.

30. The method according to claim 29, said transmission occurring over existing cellular communication networks.

31. The method according to claim 23, if said security detection circuitry fails to detect said security device, said portable communication device emits an alert so as to inform a user of the detection failure.

32. A method for tracking personal possessions of a user comprising:
associating an object with an RFID device that is attached thereto;
attempting to detect said RFID device using a portable communication device including an RFID reader; and
if said RFID reader detects said RFID device, said portable communication device pauses for a predetermined time period and attempts to detect said RFID device again, or
if said RFID reader does not detect said RFID device—
said portable communication device determines its location using location identification circuitry contained within said portable communication device, and
alerts the user of said detection failure and prompts the user to either confirm said detection failure or instruction said communication device to ignore said detection failure,
if said user confirms said detection failure or fails to confirm or fails to instruct said communication device to ignore said detection failure, wireless communication circuitry contained within said portable communication device transmits data regarding said object and the location of said portable communication device at the time of detection failure to a central computer system.

33. The method according to claim 32, said associating step comprising affixing an RFID device onto said object, said RFID device being pre-programmed with a unique identifier, and programming said portable communication device to associate said unique identifier with the name of said object.

34. The method according to claim 32, said associating step comprising programing said portable communication device to associate said RFID device built into said object and containing a pre-programmed unique identifier with the name of said object.

35. The method according to claim 32, said location identification circuitry comprising a GPS transponder.

36. The method according to claim 32, said location identification circuitry comprising circuitry for determining the location of said portable communication device by triangulation of at least two different terrestrial signals.

37. The method according to claim 32, said central computer system sending an email to said user alerting said user of said detection failure and providing the location of said portable communication device at the time of said detection failure.

38. The method according to claim 32, said object comprising a credit card.

39. The method according to claim 38, said central computer system automatically contacting the issuer of said credit card to initiate cancellation of said credit card within a predetermined period of time from said detection failure.

40. The method according to claim 32, said RFID device including a battery thereby enabling said RFID device to independently transmit a signal to be detected by said RFID reader.

41. A method for protecting personal possessions comprising:
providing a credit card including an RFID device;
attempting to detect said RFID device using an RFID reader built in to a portable communication device; and
if said RFID reader fails to detect said RFID device, location identification circuitry built in to said portable communication device determines the location of said portable communication device at the time of detection failure.

42. The method according to claim 41, said portable communication device comprising a cellular phone.

43. The method according to claim 41, said location identification circuitry comprising a GPS transponder.

44. The method according to claim 41, said location identification circuitry comprising circuitry for determining the location of said portable communication device by triangulation of at least three different terrestrial signals.

45. The method according to claim 41, said portable communication device including wireless communication circuitry.

46. The method according to claim 45, said communication circuitry transmitting information about said credit card and the location of said portable communication device to a central computer system if said RFID reader fails to detect said RFID device.

47. The method according to claim 46, said central computer system alerting the owner of said credit card of said detection failure.

48. A method of retrofitting an electronic device having a battery for tracking personal possessions of a user, said device not originally manufactured with personal possession tracking capability, said method comprising:
replacing the battery of the electronic device with a replacement battery comprising at least one component selected from the group consisting of security device detection circuitry, location identification circuitry, wireless communication circuitry, or a combination thereof.

49. The method of claim 48, said replacement battery further comprising an interface permitting communication between said at least one component of said replacement battery and the electronic device.

50. The method of claim 48, said electronic device comprising a cellular phone and said replacement battery including at least security device detection circuitry.

51. The method of claim 50, said security device detection circuitry capable of communication with a security device located on or within an object to be tracked.

52. The method of claim 51, said security device comprising an RFID device.
